(19) United States
(12) Patent Application Publication
(10) Pub. No.: US 2006/0030973 A1
(43) Pub. Date: Feb. 9, 2006

(54) Method and device for managing the consumption of energy of proximity sensor of a device for control of access to a motor vehicle cabin

(75) Inventor: Alain Brillon, Villeneuve-Tolosane (FR)

Correspondence Address: YOUNG & THOMPSON, 745 SOUTH 23RD STREET, 2ND FLOOR, ARLINGTON, VA, 22202, US

(73) Assignee: SIEMENS VDO AUTOMOTIVE, TOULOUSE CEDEX 1 (FR)

(21) Appl. No.: 11/186,801

(22) Filed: Jul. 22, 2005

(30) Foreign Application Priority Data
Jul. 23, 2004 (FR) 0408184

(51) Int. Cl. G06F 17/00

(52) U.S. Cl. 701/1

(57) ABSTRACT

A method of managing the energy consumption of a proximity sensor mounted on a handle of a door of a vehicle. This sensor detects an actuation of the handle and activates a device for control of access to the vehicle. The method includes supplying the proximity sensor so as to instigate: either a mode of operation termed current, during which the proximity sensor is supplied electrically, so as to control a periodicity of measurements which is suitable for activating the access control device in a time span that is short enough, and in particular before the handle has been fully actuated, or a mode of operation termed idle, implemented after a predetermined duration of non-use of the vehicle, in which the proximity sensor is supplied electrically so as to control a periodicity of proximity measurements that is less than that of the current mode of operation.

The invention relates to a method and a device for managing the consumption of energy of a proximity sensor of a device for control of access to a motor vehicle cabin.

Devices for controlling access to the cabin of motor vehicles conventionally comprise electronic means suitable for interrogating a transmitter/receiver circuit integrated into a badge carried by a person wishing to access this cabin, then for identifying a predetermined code transmitted in response by the badge and, finally, for controlling, after identification, unlocking of a door.

These access control devices furthermore comprise means of activation of the electronic means, able to control the triggering of an identification cycle upon the detection of a person wishing to access the cabin of the vehicle.

These means of activation are conventionally composed, at the present time, of a proximity sensor intended to be fitted on the internal face of a door handle so as to detect the hand of a person actuating this handle.

One of the operating imperatives of these access control devices consists in the obligation to obtain unlocking of the door before full actuation of the handle, failing which the unlocking mechanism is disabled, preventing the opening of the door.

Having regard to this imperative, all of the activation, control and unlocking operations must be effected in a very short time span of the order, in practice, of 100 to 150 ms.

Like the other operations, the step of detecting the person and of activating the electronic means must therefore be, likewise, very short, and it compels the use of proximity sensors able to exhibit very high performance as regards reaction times.

However, the obtaining of optimal reaction times relating to these proximity sensors also necessitates that they be supplied electrically accordingly, so as to optimize the frequency of the measurements performed.

As a result of this requirement, the proximity sensors turn out to constitute energy consumers that may give rise to discharging of the battery after several days of immobilization of the vehicle, or, at the very least play a part in this discharging.

With a view to solving this problem, a solution consists, on the one hand, in programming a cut-off of the electrical supply to the proximity sensors after a predetermined duration of non-use of the vehicle and, on the other hand, in equipping the access control devices with manually triggered switches integrated into the handles and intended to substitute for the proximity sensors once the latter are no longer energized.

Having regard to the relatively slow reaction time of the switches, this solution leads to resigning oneself to accepting that some disturbance is caused to motorists who find themselves obliged, without apparent reason, to actuate the handle again to obtain the unlocking of the door.

Moreover, and above all, this solution makes it necessary to equip each access control device with a switch, intended to be rarely active, but indispensable in its function, which leads to a not inconsiderable additional cost of the control device.

The invention aims to alleviate this drawback and its main objective is to provide a method of managing the consumption of energy of a proximity sensor of an access control device, making it possible, without increasing the potential risks of discharging of a battery, to activate this control device exclusively by means of a proximity sensor.

For this purpose, the invention is aimed at a method of managing the consumption of energy of a proximity sensor supplied from a motor vehicle battery and suitable for being mounted on a handle of a door for access to the cabin of said motor vehicle, with a view to detecting an actuation of said handle and of activating a device for control of access to said cabin, said method of management being characterized in that the proximity sensor is supplied in such a way as to instigate:
either a mode of operation termed current, in the course of which the proximity sensor is supplied electrically, so as to control a periodicity of proximity measurements which is suitable for activating the access control device in a time span, following a start of actuation of the handle, that is short enough to allow said access control device to perform an access control procedure and to possibly unlock the door before the handle has been fully actuated,
or a mode of operation termed idle, implemented after a predetermined duration of non-use of the vehicle, in the course of which the proximity sensor is supplied electrically so as to control a periodicity of proximity measurements that is less than that of the current mode of operation, unsuitable, in practice, for activating the access control device in a time span, following a start of actuation of the handle, that is short enough to allow said access control device to perform its access control procedure and to possibly unlock the door before the handle has been fully actuated.

According to the invention, the management of the consumption of energy of the proximity sensors has therefore consisted in instigating an idle mode of operation during which these sensors are still energized, but possess a level of consumption that may be reduced to the extreme, so as to be compatible with continuous supplying of said sensors with no actual influence on any problem of discharging the battery.

By way of example, according to an advantageous mode of implementation, the proximity sensor is supplied so as to obtain a ratio of the order of 1 to 100 between the periodicities of measurements of the modes of operation termed idle and current.

It should be noted that the invention leads, moreover, to the obtaining of a manner of operation identical to that obtained at the present time by means of a manually triggered switch, since, in idle mode, the periodicity of the measurements is too small to permit a reaction time leading to unlocking before the end of the movement of the handle.

Consequently, the invention leads to the obtaining of performance results equivalent to those of the present means of activation, on the basis of means of activation of a very attractive cost price as compared with that of the existing means of activation.

According to a first advantageous variant mode of implementation, and with a view to the instigation of one of the modes of operation, current or idle, the supply to the proximity sensor is regulated, and consequently the periodicity of the measurements is adjusted, in a software manner in particular by using the frequency of an internal clock of a microprocessor.

According to another advantageous variant mode of implementation, still with a view to the instigation of one of the modes of operation, current or idle, the supply to the proximity sensor is regulated, and consequently the periodicity of the measurements is adjusted, in an analog manner, by varying the charging time of a capacitor used so as to supply the proximity sensor during the discharging thereof triggered for a predetermined charging voltage Vm.

The invention extends to a device for managing the consumption of a proximity sensor supplied from a motor vehicle battery and suitable for being mounted on a handle of a door for access to the cabin of said motor vehicle, with a view to detecting an actuation of said handle and of activating a device for control of access to said cabin. According to the invention, this management device comprises:
means of electrical supply of the proximity sensor that are suitable for making it possible to instigate:
either a mode of operation termed current, in the course of which the proximity sensor is supplied electrically, so as to control a periodicity of proximity measurements which is suitable for activating the access control device in a time span, following a start of actuation of the handle, that is short enough to allow said access control device to perform an access control procedure and to possibly unlock the door before the handle has been fully actuated,
or a mode of operation termed idle, implemented after a predetermined duration of non-use of the vehicle, in the course of which the proximity sensor is supplied electrically so as to control a periodicity of proximity measurements that is less than that of the current mode of operation, unsuitable, in practice, for activating the access control device in a time span, following a start of actuation of the handle, that is short enough to allow said access control device to perform its access control procedure and to possibly unlock the door before the handle has been fully actuated,
a unit for managing the means of electrical supply which is able to make it possible to instigate one of the modes of operation, current or idle, of the proximity sensor.

According to an advantageous embodiment, the means of supply of the proximity sensor are suitable for obtaining a ratio of the order of 1 to 100 between the periodicities of measurements of the modes of operation termed idle and current.

According to the invention, the means of electrical supply of the proximity sensor may also advantageously comprise a microprocessor incorporating an internal clock, connected to said proximity sensor and programmed, with a view to the instigation of one of the modes of operation, current or idle, so as to regulate the supply to the proximity sensor, and consequently to adjust the periodicity of the measurements.

According to another advantageous embodiment, the means of electrical supply of the proximity sensor may also comprise:
a capacitor integrated into an RC circuit exhibiting a load resistor that can be adjusted between two values determining two different predetermined rates of charging of said capacitor,
means of selection of the value of the load resistor of the capacitor,
and means of measurement of the charging voltage Vin of the capacitor, which are suitable for triggering the discharging thereof and for supplying the proximity sensor, for a predetermined charging voltage Vin=Vm.

According to this analog solution, furthermore, and in an advantageous manner according to the invention, the load resistor consists of two resistors mounted in series, the means of selection of the value of said load resistor comprising a switch mounted in parallel with one of said resistors.

Other characteristics, aims and advantages of the invention will emerge from the detailed description which follows with reference to the appended drawings which represent a nonlimiting exemplary preferential embodiment thereof. In these drawings:

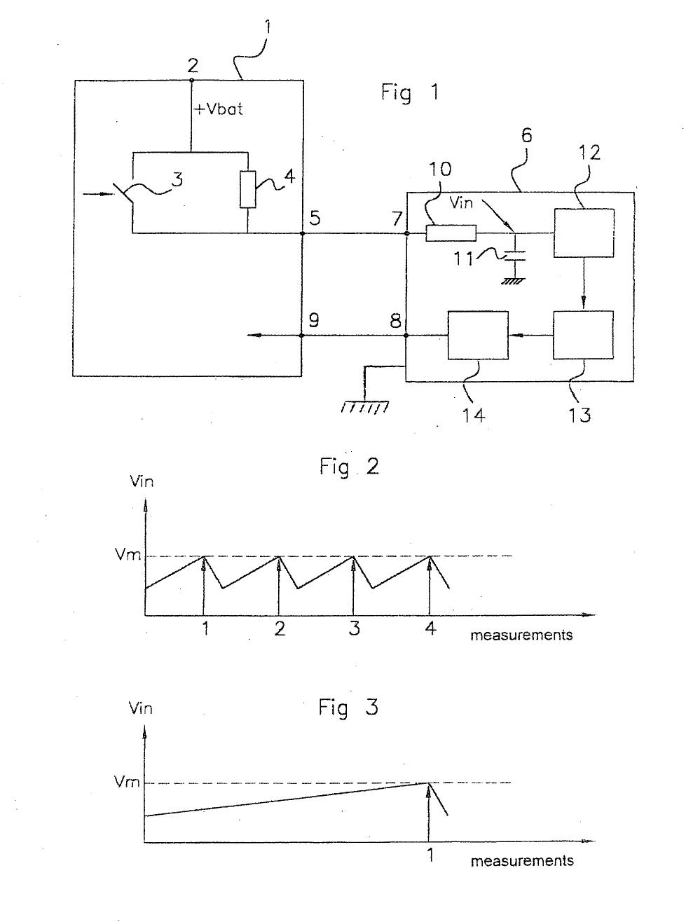

FIG. 1 is a functional schematic diagram of a device according to the invention for managing the energy consumption of a proximity sensor,

FIG. 2 is a curve representative of the periodicity of triggering of a proximity sensor, within the framework of a current mode of operation of a management device according to the invention,

FIG. 3 is a curve representative of the periodicity of triggering of a proximity sensor, within the framework of the idle mode of operation of this management device.

The device according to the invention represented by way of example in FIG. 1 is designed to ensure the management of the energy consumption of the proximity sensor, serving as activation member, of a device for control of access to a motor vehicle cabin conventionally comprising electronic means suitable for interrogating a transmitter/receiver circuit integrated into a badge carried by a person wishing to access this cabin, then to identify a predetermined code transmitted in response by the badge, and, finally, to control, after identification, unlocking of a door.

In a conventional manner, the proximity sensor is intended to be fitted on the internal face of a door handle so as to detect the presence of a hand of a person actuating this handle, and to activate the access control device immediately.

The management device, by dint of its own functions, is designed to be integrated into an access control device comprising, in a conventional manner, a management central unit 1 furnished with a supply terminal 2 for linking to a vehicle battery, and a detection peripheral unit 6.

These two units 1, 6 comprise two terminals, respectively 5, 7 with a view to their electrical connection intended for the electrical supplying of the peripheral unit 6, as well as two terminals, respectively 8, 9, with a view to their serial linking intended for the transmission by the peripheral unit 6 of a “wake-up” activation signal for the central unit 1.

In a specific manner according to the invention, the central unit 1 comprises, mounted in parallel between the two electrical connection terminals 2, 5, a switch 3 and an electrical resistor 4.

The peripheral unit 6 comprises, for its part firstly, connected to the input terminal 7, an RC circuit composed of an electrical resistor 10 and of a capacitor 11 which is able to be charged across said resistor.

This peripheral unit 6 furthermore comprises a comparator 12 connected so as to measure the charging voltage Vin of the capacitor 11, and to control the discharging of said capacitor for a predetermined charging voltage Vin=Vm.

This peripheral unit 6 also comprises a proximity sensor 13, of the infrared sensor or capacitive sensor type, connected in such a way as to be periodically supplied upon each discharging of the capacitor 11.

This peripheral unit 6 comprises, finally, a digital filter 14 suitable for validating the information emanating from the proximity sensor 13 after reception of two or three successive analog detection signals.

According to the invention, in the current mode of operation, the switch 3 is closed so that the periodicity of supply of the proximity sensor 13 is determined solely by the value of the resistor 10 of the RC circuit.

In a conventional manner, the value of this resistor 10 is adjusted in such a way that a measurement is performed by the proximity sensor 13 substantially every millisecond, this periodicity, represented in FIG. 2, proving to be, in fact, that which satisfies the requirement of speed of reaction imposed by the principle of operation of the access control devices.

On the other hand, after a predetermined duration of non-use of the vehicle, for example two or three days of non-use, the central unit 1 is programmed to toggle the switch 3 to its open state.

The access control device is then itself toggled to its idle mode of operation during which the periodicity of supply of the proximity sensor 13 is determined by the aggregate value of the resistors 4 and 10.

According to the invention, this aggregate value is calculated to obtain a periodicity which is much less than that of the current mode of operation, for example in a ratio of 1 to 100.

This periodicity, which therefore leads to controlling a measurement approximately every one hundred milliseconds, is designed to minimize the energy consumption of the proximity sensor 13, while providing an idle mode making it possible to “wake up” the access control device and to unlock the door after two actuations of the handle for opening this door.

Furthermore, according to the principle of the invention, the idle mode requires simply, as compared with a contemporary access control device, a few alterations to the software of the central unit 1, and the addition of the resistor 4.

1. A method of managing the consumption of energy of a proximity sensor (13) supplied from a motor vehicle battery and suitable for being mounted on a handle of a door for access to the cabin of said motor vehicle, with a view to detecting an actuation of said handle and of activating a device for control of access to said cabin, said method of management being characterized in that the proximity sensor (13) is supplied in such a way as to instigate:
either a mode of operation termed current, in the course of which the proximity sensor (13) is supplied electrically, so as to control a periodicity of proximity measurements which is suitable for activating the access control device in a time span, following a start of actuation of the handle, that is short enough to allow said access control device to perform an access control procedure and to possibly unlock the door before the handle has been fully actuated,
or a mode of operation termed idle, implemented after a predetermined duration of non-use of the vehicle, in the course of which the proximity sensor (13) is supplied electrically so as to control a periodicity of proximity measurements that is less than that of the current mode of operation, unsuitable, in practice, for activating the access control device in a time span, following an actuation of the handle, that is short enough to allow said access control device to perform its access control procedure and to possibly unlock the door before the handle has been fully actuated.

2. The method of management as claimed in claim 1, characterized in that the proximity sensor (13) is supplied so as to obtain a ratio of the order of 1 to 100 between the periodicities of measurements of the modes of operation termed idle and current.

3. The method of management as claimed in claim 1, characterized in that, with a view to the instigation of one of the modes of operation, current or idle, the supply to the proximity sensor (13) is regulated, and consequently the periodicity of the measurements is adjusted, in a software manner in particular by using the frequency of an internal clock of a microprocessor.

4. The method of management as claimed in claim 1, characterized in that, with a view to the instigation of one of the modes of operation, current or idle, the supply to the proximity sensor (13) is regulated, and consequently the periodicity of the measurements is adjusted, in an analog manner, by varying the charging time of a capacitor (11) used so as to supply the proximity sensor (13) during the discharging thereof triggered for a predetermined charging voltage Vm.

5. A device for managing the consumption of a proximity sensor (13) supplied from a motor vehicle battery and suitable for being mounted on a handle of a door for access to the cabin of said motor vehicle, with a view to detecting an actuation of said handle and of activating a device for control of access to said cabin, said management device being characterized in that it comprises:
means of electrical supply (2, 3, 4, 10, 11) of the proximity sensor (13) that are suitable for making it possible to instigate:
either a mode of operation termed current, in the course of which the proximity sensor (13) is supplied electrically, so as to control a periodicity of proximity measurements which is suitable for activating the access control device in a time span, following a start of actuation of the handle, that is short enough to allow said access control device to perform an access control procedure and to possibly unlock the door before the handle has been fully actuated,
or a mode of operation termed idle, implemented after a predetermined duration of non-use of the vehicle, in the course of which the proximity sensor (13) is supplied electrically so as to control a periodicity of proximity measurements that is less than that of the current mode of operation, unsuitable, in practice, for activating the access control device in a time span, following a start of actuation of the handle, that is short enough to allow said access control device to perform its access control procedure and to possibly unlock the door before the handle has been fully actuated,
a unit (1) for managing the means of electrical supply (2, 3, 4, 10, 11) which is able to make it possible to instigate one of the modes of operation, current or idle, of the proximity sensor (13).

6. The management device as claimed in claim 5, characterized in that the means of supply (2, 3, 4, 10, 11) of the proximity sensor (13) are suitable for obtaining a ratio of the order of 1 to 100 between the periodicities of measurements of the modes of operation termed idle and current.

7. The management device as claimed in claim 5, characterized in that the means of electrical supply of the proximity sensor (13) comprise a microprocessor incorporating an internal clock, connected to said proximity sensor and programmed, with a view to the instigation of one of the modes of operation, current or idle, so as to regulate the supply to the proximity sensor (13), and consequently to adjust the periodicity of the measurements.

8. The management device as claimed in claim 5, characterized in that the means of electrical supply (2, 3, 4, 10, 11) of the proximity sensor (13) comprise:
a capacitor (11) integrated into an RC circuit exhibiting a load resistor (4, 10) that can be adjusted between two values determining two different predetermined rates of charging of said capacitor,
means of selection (3) of the value of the load resistor (4, 10) of the capacitor (11),
and means of measurement (12) of the charging voltage Vin of the capacitor (11), which are suitable for triggering the discharging thereof and for supplying the proximity sensor (13), for a predetermined charging voltage Vin=Vm.

9. The management device as claimed in claim 8, characterized in that the load resistor consists of two resistors (4, 10) mounted in series, the means of selection of the value of said load resistor comprising a switch (3) mounted in parallel with one of said resistors.

10. The method of management as claimed in claim 2, characterized in that, with a view to the instigation of one of the modes of operation, current or idle, the supply to the proximity sensor (13) is regulated, and consequently the periodicity of the measurements is adjusted, in a software manner in particular by using the frequency of an internal clock of a microprocessor.

11. The method of management as claimed in claim 2, characterized in that, with a view to the instigation of one of the modes of operation, current or idle, the supply to the proximity sensor (13) is regulated, and consequently the periodicity of the measurements is adjusted, in an analog manner, by varying the charging time of a capacitor (11) used so as to supply the proximity sensor (13) during the discharging thereof triggered for a predetermined charging voltage Vm.

12. The management device as claimed in claim 6, characterized in that the means of electrical supply of the proximity sensor (13) comprise a microprocessor incorporating an internal clock, connected to said proximity sensor and programmed, with a view to the instigation of one of the modes of operation, current or idle, so as to regulate the supply to the proximity sensor (13), and consequently to adjust the periodicity of the measurements.

13. The management device as claimed in claim 6, characterized in that the means of electrical supply (2, 3, 4, 10, 11) of the proximity sensor (13) comprise:
a capacitor (11) integrated into an RC circuit exhibiting a load resistor (4, 10) that can be adjusted between two values determining two different predetermined rates of charging of said capacitor,
means of selection (3) of the value of the load resistor (4, 10) of the capacitor (11),
and means of measurement (12) of the charging voltage Vin of the capacitor (11), which are suitable for triggering the discharging thereof and for supplying the proximity sensor (13), for a predetermined charging voltage Vin=Vm.
